(19) United States
(12) Patent Application Publication
(10) Pub. No.: US 2003/0054804 A1
(43) Pub. Date: Mar. 20, 2003

(54) Method for the transmission of information by means of a broadcast transmitter, method for receiving information transmitted by a broadcast transmitter, method for the control of a broadcast receiver and a broadcast receiver

(76) Inventors: Axel Brandes, Lahstedt (DE); Cornelius Hahlweg, Hildesheim (DE)

Correspondence Address: KENYON & KENYON, ONE BROADWAY, NEW YORK, NY, 10004, US

(21) Appl. No.: 10/070,075

(22) PCT Filed: May 3, 2001
(86) PCT No.: PCT/DE01/01683

(30) Foreign Application Priority Data
Jun. 30, 2000 (DE) 100 31 981.5

(51) Int. Cl. H04M 3/42

(52) U.S. Cl. 455/414; 455/452

(57) ABSTRACT

The present invention provides a method for transmitting data via a radio transmitter, the data including at least one Internet address; a method for receiving data broadcast by a radio transmitter, the data including at least one Internet address; a radio receiver having a recognition circuit for the isolation of Internet addresses from received data transmitted by radio; and a method for controlling a radio receiver, or a device connected to the radio receiver, by data received by the radio receiver, the data including at least one Internet address, the at least one Internet address being formulated as a query for specific data made available by a provider, and the radio receiver or the device connected to the radio receiver being controlled as a function of data queried via a communication interface in accordance with the at least one received Internet address. The present invention makes possible the transmission, to a radio receiver according to the present invention or a device connected thereto, of displayable data or of data usable for controlling the receiver, with a particularly high data rate and data security, by using existing radio transmission systems such as RDS, and utilizing additional transmission capacities of the Internet.

### FIELD OF THE INVENTION

The present invention relates to a method for transmitting data via a radio transmitter, a method for receiving data broadcast by a radio transmitter, a radio receiver, and a method for controlling a radio receiver.

### BACKGROUND INFORMATION

Methods for transmitting data via a radio transmitter are known. For example, present-day radio transmitters such as broadcast audio or television programs using radio frequencies, which are frequency-modulated with the data to be transmitted, in the form of electromagnetic waves via terrestrial transmission antennas. Known transmission methods also include cable (e.g. cable television) and digital radio transmission (e.g. digital audio broadcasting or DAB), in which a plurality of carrier frequencies are modulated by a digital radio program signal.

Also known is transmission by way of the radio frequencies which contain actual program signals (e.g. an audio program) and further data that does not negatively affect the actual program signals. This is known from “DIN EN 50 067, Specification for the Radio Data System (RDS),” Deutsche Elektrotechnische Kommission in DIN and VDE (DKE), Beuth Verlag GmbH, Berlin, February 1992, which is ultimately based on “Tech. 3244-E, Specifications of the radio data system for VHF/FM sound broadcasting,” European Broadcasting Union, Brussels, March 1984, to provide in the baseband signal, in which the audio program occupies a frequency range from 0 to 53 kHz, a subcarrier at a frequency of 57 kHz that is amplitude-modulated by a data signal present in digital form, and to modulate the radio frequency with that multiplex signal. The data contained in the digital data signal serve to automatically tune a radio receiver (especially a mobile one) to optimize the reception quality of a received audio program, and moreover to inform the listener.

Existing radio transmission systems established with extensive coverage, in particular the above-described Radio Data System (RDS) for audio broadcasting or the Videotext system for television broadcasting, have limited transmission capacity for data signals. In the case of the Radio Data System, the transmission capacity for data signals is defined by the data rate stipulated in the aforementioned RDS specification. Due to the proximity of the subcarrier to the spectrum of the audio signal, an expansion of the frequency range occupied by modulation of the subcarrier with the data signal is not possible. An occasionally fluctuating or insufficient reception quality is another obstacle to an increase in the data rate of the RDS signal, which with a higher data rate would result in a further degradation of the receivability of the data signal. This is particularly true with mobile radio receivers.

German Patent No. 35 36 820 C2 describes one possibility for displaying in a mobile radio receiver a traffic message that comprises a large data volume. The codes containing memory addresses are broadcast by the data signal of the Radio Data System. The memory addresses correspond to memory cells in the mobile radio receiver in which defined components of traffic data that are to be displayed are stored. By transmitting a suitable address sequence, complex data may be displayed by synthesizing the data from predefined stored data components. This method is known as TMC (Traffic Message Channel). However, the TMC method is not suitable for increasing transmission capacity and it requires that receiver-side memory capacity must be provided to store the data components. The volume and nature of the data that may be displayed are limited by the contents of the receiver-side memory. Also, correct reception of the additional data is often not ensured, especially in the context of changeable reception situations in mobile radio receivers.

### SUMMARY OF THE INVENTION

The method according to the present invention for transmitting data via a radio transmitter and the method according to the present invention for receiving data broadcast by a radio transmitter have the advantage of creating a capability for increasing the transmission capacity for the transmission of data from a radio provider to a radio receiver. For this purpose existing radio transmission systems are combined, without complex modifications, with the capabilities of the Internet which possesses a high data transmission capacity.

In this context an Internet address is transmitted as part of a data signal transmitted alongside program content. This prevents any negative effect on the program signal by the transmitted Internet address.

The transmission of Internet addresses is accomplished by use of widely disseminated transmission paths accepted by the user, e.g. in particular the Radio Data System or the SWIFT/DARC standard in the case of radio broadcasting, or the Videotext signal in the case of television broadcasting.

After corresponding dissemination and acceptance by users, radio signals broadcast according to a standard for digital terrestrial or satellite radio, in particular according to the Digital Audio Broadcasting (DAB) standard or Digital Satellite Radio (DSR) standard. These standards are of particular interest as transmission mediums for Internet addresses because of their higher transmission capacity.

After transmission of an Internet address into a radio receiver, that address is automatically selected via a communication interface, in particular a broadcast interface. This relieves the user of input operations that in some circumstances are perceived as burdensome; this is of interest in the case of radio receivers in vehicles, in the interest of greater driving safety.

The data retrievable at the transmitted Internet address may also be used to control the radio receiver or components connected to the radio receiver or to the communication interface. For example AF lists usually transmitted by the RDS signal, which in the case of a mobile radio receiver often may be received only partially or erroneously because of poor reception conditions. Transmission of auxiliary control data via the communication interface is less error-prone, and because of the higher transmission capacity is performed more quickly than via radio.

The method according to the present invention for controlling a radio receiver or a device connected to the radio receiver has the advantage that the radio receiver may be caused, by way of control data broadcast via radio and formulated as an Internet address, to automatically access specific data of an Internet provider and to perform control functions as defined by the data of the Internet provider, or to make the data of the Internet provider accessible to the device connected to the radio receiver to control its functions. This offers the particular advantage that the provider's data may be loaded or transmitted via the Internet at a high data rate and moreover with high data security.

### BRIEF DESCRIPTION OF THE DRAWINGS

FIG. 1 illustrates a radio transmitter that broadcasts a radio program signal generated by a radio provider on a radio frequency as a radio signal; and a block diagram of a radio receiver for receiving the radio signal and for evaluating the data contained in the radio signal.

FIG. 2 illustrates the construction of a data signal according to the RDS standard.

### DETAILED DESCRIPTION

In conjunction with the present invention, the term “radio” is not limited to the meaning often given to it, of sound broadcasts transmitted via an AM- or FM-modulated radio frequency. “Radio” is understood here as any transmission of data of a data provider to a plurality of receivers. Examples include FM or AM audio broadcasting, terrestrial digital audio broadcasting known as DAB (Digital Audio Broadcasting), digital satellite-based audio broadcasting known as DSR (Digital Satellite Radio), and satellite, cable, and terrestrial television.

In conjunction with the present invention, “radio” is not limited to wireless broadcast transmission by electromagnetic waves, but rather extends beyond that to both wireless and cable-based transmission, for example via copper or glass-fiber lines.

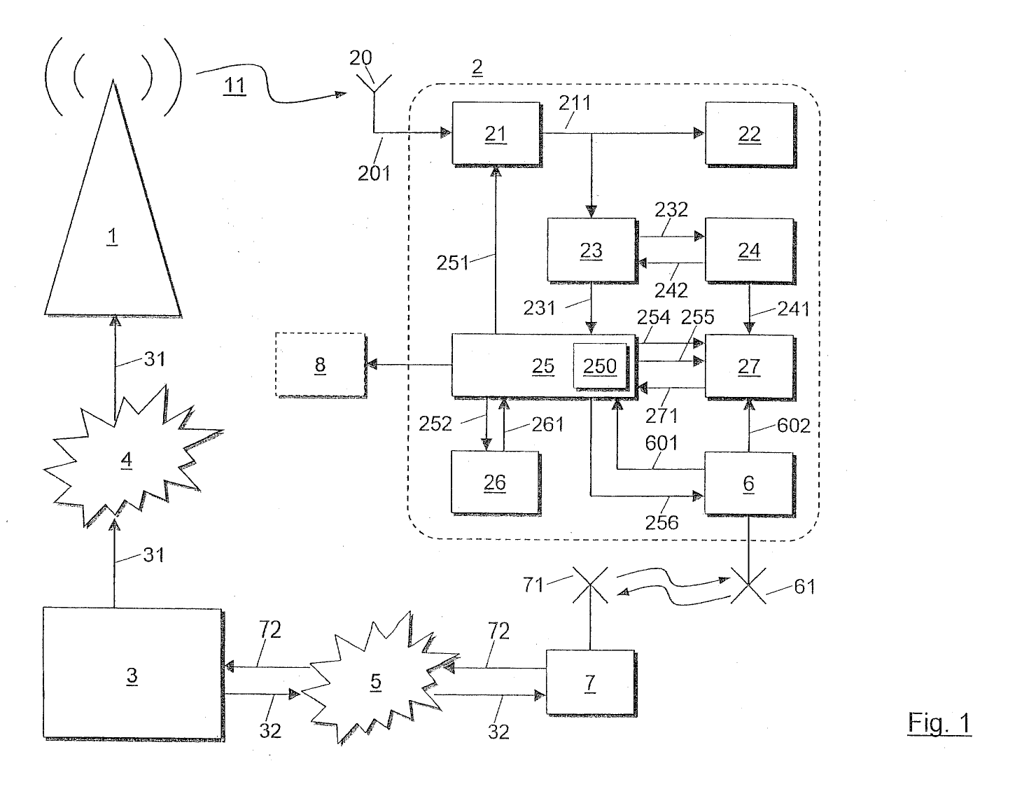

The method according to the present invention for transmitting data via a radio transmitter, the method according to the present invention for receiving data broadcast by a radio transmitter, and a radio receiver according to the present invention are explained below using the example of an RDS radio transmitter and an RDS radio receiver provided for mobile use, in particular in a motor vehicle, which are depicted in FIG. 1.

A radio provider 3 generates a radio program signal 31 that comprises an audio program signal, namely music or voice segments, that are provided for acoustic reproduction in a radio receiver. In addition to the audio program signal, radio program signal 31 that is to be transmitted contains a data signal which contains additional data provided in the aforementioned RDS specification.

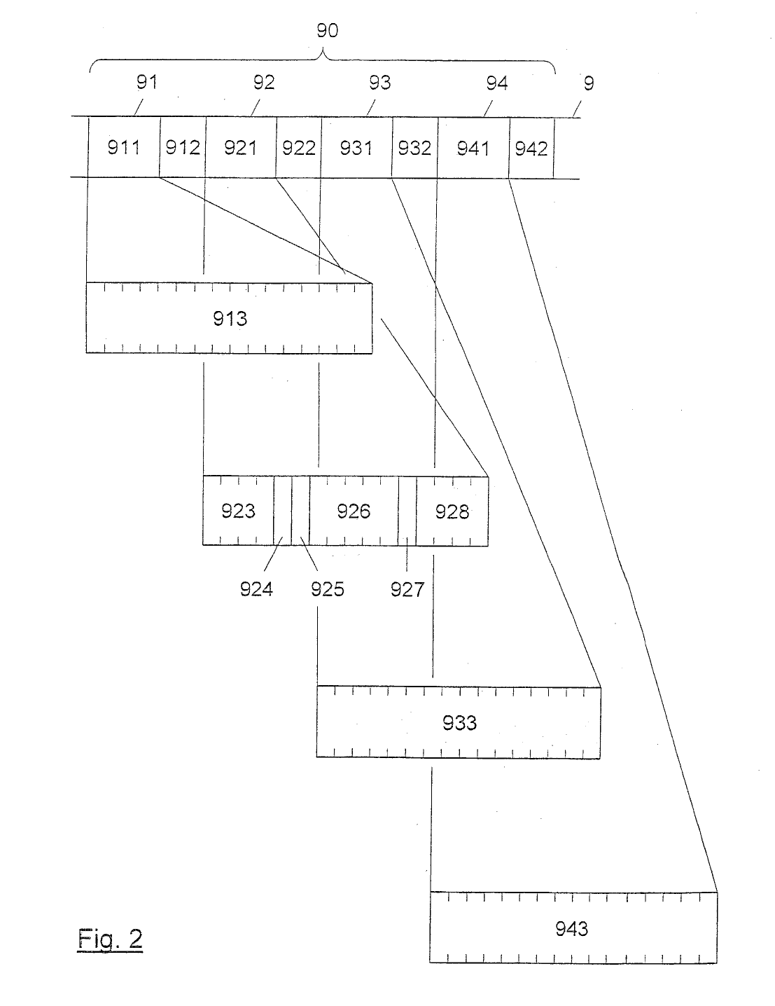

The RDS information signal, a portion 9 of which is depicted in FIG. 2, is made up of a sequence of data groups, called groups 90. Each of the groups encompasses four data blocks, called blocks 91, 92, 93, and 94, which usually are referred to as blocks A, B, C, and D. Each block encompasses 26 bits; the first sixteen bits of each block constitute the actual data word 911, 921, 931, and 941, while the remaining ten bits 912, 922, 932, and 942 of each block represent a superposition of a test word derived from the data word, which serves for error detection and (if applicable) correction, and an offset word that allows block synchronization of a radio receiver.

For transmission of different types of data, the RDS specification provides for different group types which are serially arranged in an undefined sequence to form the RDS data signal. Specific data types regarded as particularly important are transmitted in all or a majority of the group types. Other information, of greater volume, is limited to specific group types. The proportions of specific group types in the RDS signal and the repetition rate are defined in the RDS specification for specific group types; the remaining transmission capacity may be used at the transmitter end for any desired data and therefore any group types in the context of the RDS specification.

Data word 921 of block B 92 contains a four-bit group type identifier 923 to identify the group type. A version bit 924 following the group type identifier serves to identify two different versions of the same group type. Regardless of the group type, group type identifier 923 and version bit 924 are always transmitted in data word 921 of block B 92.

Also adjacent to group type version bit 924 in data word 921 of block B, regardless of the group type, are a one-bit traffic program (TP) identifier 925, which indicates whether traffic data are being transmitted within the received radio program; and a five-bit program type (PTY) identifier 926 for distinguishing among, for example, news, sports, and music programs of various styles.

Data word 911 of block A 91 contains, again regardless of the group type, a program identifier (PI) 913 that is uniquely associated with a radio program and thus permits unequivocal identification of a radio program. Since a specific radio program is usually broadcast by a plurality of radio transmitters and on a plurality of radio frequencies, the program identifier allows a radio receiver to automatically locate those radio frequencies on which a specific program is being broadcast. If reception of a radio frequency currently being received is deteriorating, it is thus possible on the basis of the program identifier to ascertain alternative radio frequencies that are broadcasting the same program and possibly exhibit, at the present receiver location, better reception quality than the radio frequency presently being received. In the case of a group of group type version B, i.e. in which version bit 924 has a logical value of “1”, data word 931 of block C 93 also includes the program identifier (PI).

Data word 941 of block D 94 makes available other group-type-specific data. The same is true of data word 931 of block C 93 in the context of a version A group, i.e. in which group type bit 924 has a logical value of “0”.

In the context of group type 2, radiotext data (RT) 943 (or 943 and 933) are transmitted in data word 941 of block D 94 (and in the case of version A, also in data word 931 of block C 93). “Radiotext” is a coded character transmission, the transmitted characters being provided in accordance with the RDS specification for display on a display unit of a radio receiver.

In the case of a type 2 group, the remaining five bits of data word 921 of block B contain on the one hand a so-called text A/B flag 927, and a text segment address 928. Text segment address 928, constituting the last four bits of data word 921 of block B, indicates the position at which the characters transmitted in block D (group 2B) or blocks C and D (group 2A) are to be displayed within the character display. The text A/B flag, indicates whether the transmitted characters are to overwrite an existing character display, or if the displayed characters are to be deleted before the characters currently being transmitted are displayed.

According to the present invention, the RDS data signal is also used to transmit Internet addresses, Uniform Resource Locators, or (URLs). In the present exemplary embodiment, a URL is transported in a type 2 group instead of or as part of a radiotext datum.

An URL contains the address and name of a WWW document as well as a selected transmission protocol, such as Hypertext Transfer Protocol(http). Alternatively, a URL may also contain concrete query commands.

The URL is made known by way of a characteristic character sequence within radiotext information 943 of block D (group type B) or 933 and 943 of blocks C and D (group type 2A). The character sequence identifying an Internet address may be a constituent of the Internet address itself, and for example may be constituted by or encompass the familiar character sequence “//” that introduces an Internet address. To identify the end of an Internet address, especially when the Internet address is transmitted within a radiotext character sequence provided for display on display unit 26, provision is made to distinguish characters of the Internet address from radiotext characters that are to be displayed, for marking the end of the Internet address, preferably by a distinctive character sequence, e.g. “//”. Preferably an URL within the RDS RT information is terminated by a character sequence that differs from the character sequence which introduces an URL (i.e. “//” in the selected example), for example “\\”. This prevents any transmitter-side misinterpretation of a terminating character sequence “//” as the beginning of an Internet address if the introductory character sequence “//” was not received, for example because of low reception quality at the receiver location or because reception of the RDS signal began during transmission of the URL.

Alternative possibilities for identifying an URL within the RDS signal are possible and are within the scope of the present invention. For example, it is possible to reserve and use for the transmission of URLs group types of the RDS signal that have not previously specified in detail. An URL is then recognizable, from the group type.

Radio program signal 31 generated by the radio provider, which encompasses the audio program signal and the RDS data signal containing at least one Internet address, is conveyed to at least one radio transmitter 1 via a first communication network 4, which is configured for example in the form of a cable connection or a radio relay connection between radio provider 3 and radio transmitter 1. Transmission of radio program signal 31 from provider 3 to radio transmitter 1 is accomplished in such a way that the audio program signal and data signal, the latter in the form of a digital data stream, are conveyed to radio transmitter 1 as separate signals. Radio transmitter 1 has an RDS modulator that amplitude-modulates a 57 kHz subcarrier with the digital data stream of the RDS data signal, supplemented with transmitter-specific data such as a list of alternative radio frequencies.

The list of alternative radio frequencies (AF), also defined in the RDS specification, contains those radio frequencies on which the same radio program 31 is being broadcast. It is proposed in previously published European Patent No. 0 527 275 B1 to broadcast the lists of alternative radio frequencies within the RDS data signal in such a way that each radio frequency of the broadcasting radio transmitter is transmitted in paired fashion with a radio frequency of another radio transmitter.

According to Europen Patent No. 0 527 275 B1, radio transmitter 1 adds to the RDS data stream generated by radio provider 3 the transmitter-specific list of alternative frequencies (AF), in which each alternative radio frequency on which the same program is being broadcast is associated in paired fashion with the radio frequency of radio transmitter 1, yielding the RDS data signal that is to be transmitted. The alternative frequencies are preferably conveyed to radio transmitter 1 as part of the RDS data stream.

The radio transmitter moreover has a multiplexer in which the audio program signal, which occupies a frequency range from 0 to 53 kHz in the baseband, is combined in known fashion with the 57-kHz subcarrier amplitude-modulated by the RDS data signal to yield the multiplex signal which is to be transmitted, containing the data of radio program signal 31.

In a frequency modulator of radio transmitter 1, the radio frequency of radio transmitter 1 is frequency-modulated, again in a known fashion, with the multiplex signal containing the radio program signal to form radio signal 11; and radio signal 11 is broadcast via a transmitting antenna of radio transmitter 1 in the form of electromagnetic radiation.

Radio signal 11 of radio transmitter 1 is received by a receiving antenna 20 of a radio receiver 2 located within the transmission range of radio transmitter 1. If further radio transmitters are receivable at the present location of radio receiver 2, antenna signal 201 of receiving antenna 20 of radio receiver 2 consists of a superposition of radio signals of various radio transmitters, from which radio signal 11 of radio transmitter 1 is selected by a receiver section 21 of the radio receiver that may be tuned as a function of a tuning control signal 251. Receiver section 21 has, in a conventional manner, the capability necessary for reception and selection of one of a plurality of receivable radio signals. The receiver section also has a frequency demodulator, so that multiplex signal 211 modulated with the radio frequency of radio transmitter 1 is present at the output of receiver section 21.

Multiplex signal 211 is conveyed to a reproduction apparatus 22 that has, in a conventional manner, the capability necessary for acoustic reproduction of the audio program signal contained in multiplex signal 211.

Multiplex signal 211 is additionally conveyed to an RDS decoder 23 that has, in a conventional manner, the capability necessary for isolating the RDS data from multiplex signal 211. A first output of RDS decoder 23 makes available for further processing RDS data 232 recovered from multiplex signal 211, including program identifier 913.

The radio receiver furthermore has a controller 25 for controlling the functions of radio receiver 2; and a user interface 26, connected to controller 25, which encompasses a display unit activated on the basis of a display control signal 252 generated by controller 25, and an input unit for the input of operating commands by the user, which are conveyed as operating signals 261 to controller 25. Also conveyed to controller 25 are RDS data 232 made available at the first output of the RDS decoder.

Radio receivers as described to this point are commonly known and are produced and sold by the million, so that the configuration and manner of operation of the radio receivers just described may be assumed to be conventional and therefore need not be described in more detail. One example of a conventional radio receiver is a car radio unit.

The radio receiver according to the present invention has a recognition circuit 24, connected to a second output 232 of RDS decoder 23, for recognition and isolation of an Internet address transmitted as part of the radiotext information within the RDS data signal. If RDS signal groups of type 2 are contained in the received radio signal 11, the radiotext signals as well as the pertinent text segment address signals and text A/B signals are present at the second output of the RDS decoder. These signals are checked in the recognition circuit for the presence of at least one Internet address. In the case described, i.e. when an Internet address transmitted within the RT information is identified by characteristic character sequences, such as the character sequence “//” introducing an Internet address, and a second character sequence, for example “\\”, placed directly after the Internet address, recognition circuit 24 checks the RT information for precisely those characteristic character sequences. A character sequence enclosed by the characteristic character sequences is recognized by recognition circuit 24 as an Internet address.

Constituents 242 of the radiotext signal that do not contain an Internet address, but rather are provided for display on display unit 26 of radio receiver 2, are conveyed via RDS decoder 23 to controller 25, which by way of a display control signal 252 activates display unit 26 in known fashion to display the radiotext signal. Preferably these constituents 242 of the radiotext signal are delivered to controller 25 in the group format, type 2A or 2B. With respect to the radiotext signal, recognition circuit 24 thus acts as a filter that eliminates from the radiotext signal those data not provided for display on display unit 26 of the radio receiver.

An Internet address contained in the radiotext signal and recognized by recognition circuit 24 is conveyed to a memory 27 and stored, preferably together with program identifier 913 of the radio program presently being received, which is isolated by controller 25 from the RDS data present at the first output of RDS decoder 23 and conveyed to the memory as signal 254.

According to the present invention, the radio receiver described has a communication software program 250, preferably implemented in controller 25, that hereinafter is referred to simply as a browser 250. The purpose of browser 250 is to create a communication connection between radio receiver 2 and the Internet (which is depicted in the Figure as a second communication network 5) in accordance with an Internet address 271 read out from memory 27 in response to a retrieval instruction 255, and to control communication between radio receiver 2 and Internet 5. To create a communication connection between radio receiver 2 and Internet 5, browser 250 accesses a communication interface 6 that, in the present exemplary embodiment, is configured in the form of a mobile radiotelephone 6 functioning according to the GSM standard.

In accordance with an Internet address 256 conveyed to it by the browser, mobile radiotelephone 6 creates a radio connection via a transmission/reception antenna 61 to a mobile radio base station 7, equipped with a second transmission/reception antenna 71, in whose radio cell the radio receiver is located. Mobile radio base station 7 forwards query signal 72 containing Internet address 256 to Internet 5, whereupon a connection is created to the Internet data provider (“provider”) 3 identified by Internet address 256. In response to query signal 72, provider 3 makes available data 32 that are conveyed via Internet 5 to mobile radio base station 7 and from there via the existing mobile radio connection to mobile radiotelephone 6 of radio receiver 2.

For the discussion to follow, it is assumed that provider 3 selected by browser 250 in accordance with Internet address 271 is radio provider 3 whose radio program 31 is presently being received by radio receiver 2, and which also makes data 32 available via Internet 5.

The data made available by radio provider 3 via Internet 5 may be data suitable for display on display unit 26 of radio receiver 2, for example a program summary, the title and performer of a musical piece presently being transmitted, or data interactively selectable by the user by way of operating inputs on the user interface, for example in a manner comparable to the Videotext system of broadcast television.

Also, the data made available by radio provider 3 via Internet 5 may be control data for radio receiver 2, for example an AF list which, especially in the case of a radio signal received with low reception quality, is receivable via the mobile radio communication interface 6 with greater data security than via the radio signal. The data made available by radio provider 3 via Internet 5 may be Internet addresses at which, for example, different or additional data, such as data about other programs of the same radio provider, may be retrieved. Additionally, the data made available by radio provider 3 via Internet 5 may be control data for external components 8 connected to radio receiver 2, for example road condition or traffic data for a navigation device for calculating routes of travel from a starting point to a destination in consideration of stored map data and additional road condition or traffic data.

In the event the data 32 made available by provider 3 are data provided for display on a display unit, browser 250 reads Internet data 601 available in communication interface 6 into controller 25 and controls the output thereof via display unit 26 by a corresponding display control signal 252.

If additional Internet addresses 32 are present, they are written into memory 27 as a signal 602 made available by mobile radiotelephone 6.

Access to a specific Internet address 271 stored in memory 27 is accomplished either automatically upon initiation by controller 25, or in response to a corresponding user input via user interface 26.

A first alternative embodiment of the invention is directed toward radio receivers other than the RDS radio receiver described above. The radio receiver according to the present invention may also be embodied in the form of a television receiver. In this case, the Videotext signal may be used for transmission of the Internet addresses. In addition, the radio receiver may also be embodied as a receiver for digital radio, for example as a DAB (Digital Audio Broadcasting) or DSR (Digital Satellite Radio) receiver, in which context transmission channels provided in the corresponding radio transmission system are used for transmission of the Internet addresses.

A second alternative embodiment is directed toward wire-based radio transmission from radio provider 3 to radio receiver 2. The generally known systems of cable television and cable radio are examples. In the case of cable radio, the Internet addresses may again be transmitted as part of the radio data signal, and in the case of cable television, for example, as part of the Videotext signal.

A third alternative embodiment is directed toward the type of Internet access on the part of radio receiver 2. Instead of an embodiment of the communication interface as a GSM mobile radio interface, it may also function on the basis of the UMTS mobile radio standard, which on the basis of present knowledge will be widely disseminated in the future. Alternatively, in the case of a radio receiver provided for stationary (in particular, residential) operation, a wire-based connection of radio receiver 2 may be provided, for example via a telephone connection by a modem embodied as part of communication interface 6, or by an ISDN connection. Lastly, the so-called GPRS standard is also a possibility for connecting radio receiver 2 to Internet 5.

A fourth alternative embodiment is directed toward the transmission, from the radio transmitter to the radio receiver, of URLs containing query commands. These query commands may be formulated to control the radio receiver. This is explained with reference to the exemplary embodiment described below.

According to the fourth alternative embodiment, the radio transmitter transmits URLs in the form of the aforementioned query commands in such a way that the query commands access specific data offerings of provider 3 in accordance with the provider's selection. These specific data offerings may encompass, for example a list of alternative radio frequencies (AF list) broadcasting the same radio program as the one on the radio frequency presently being received. The AF list queried as a consequence of query command 72 is then transmitted as Internet data 32 by provider 3 (in the form of radio provider 3) via Internet 5, base station 7, and communication interface 6 of the radio receiver, into radio receiver 2, where it is stored in a radio frequency memory (not depicted) of the radio receiver. This ensures fast and dependable transmission of the AF list from radio provider 3 to radio receiver 2.

Similarly, additional control data may also be conveyed to radio receiver 2 via Internet 5 rather than, for example, via the radio data signal. One example is control data that influences a navigation device 8 connected as additional component 8 to radio receiver 2.

According to this, navigation device 8 calculates a route of travel from a present vehicle location, which is determined by the sensor apparatus of the navigation device, for example by a conventional GPS (Global Positioning System) receiver, to a destination defined by the user. The route calculation is performed on the basis of traffic route data stored, for example, on a CD. Preferably the route calculation may be performed in consideration of a present traffic situation, for example construction areas, traffic jams, etc., the traffic situation data usually being conveyed to the navigation device in coded form via a TMC radio receiver as mentioned above.

According to the present invention, radio receiver 2 may now have conveyed to it from radio transmitter 1, for example by the RDS signal, URLs formulated as queries that refer to current traffic situation data made available by provider 3 on the Internet. Transmission of the URL causes the radio receiver to load, via the Internet, traffic situation data 32 made available by provider 3. This data is conveyed to navigation device 8 connected to radio receiver 6, which takes it into account for route calculation. As compared to RDS TMC data, the current traffic situation data loaded via the Internet is receivable at a higher data rate and with greater data security.

### BACKGROUND INFORMATION

The invention proceeds from a method for transmitting data via a radio transmitter, a method for receiving data broadcast by a radio transmitter, a radio receiver, and a method for controlling a radio receiver, according to the species defined in the independent claims.

Methods for transmitting data via a radio transmitter are fundamentally known. Present-day radio transmitters, for example, broadcast audio or television programs using radio frequencies, which are frequency-modulated with the data to be transmitted, in the form of electromagnetic waves via terrestrial transmission antennas. Alternative transmission media, for example cable (one example being cable television) and transmission methods such as digital radio transmission (e.g. digital audio broadcasting or DAB), in which a plurality of carrier frequencies are modulated by a digital radio program signal, are also known.

It is furthermore known to transmit by way of the radio frequencies, in addition to the actual program signals (e.g. an audio program), further data that do not negatively affect the actual program signals. It is known, for example, from “DIN EN 50 067, Specification for the Radio Data System (RDS),” Deutsche Elektrotechnische Kommission in DIN and VDE (DKE), Beuth Verlag GmbH, Berlin, February 1992, which is ultimately based on “Tech. 3244-E, Specifications of the radio data system for VHF/FM sound broadcasting, ” European Broadcasting Union, Brussels, March 1984, to provide in the baseband signal, in which the audio program occupies a frequency range from 0 to 53 kHz, a subcarrier at a frequency of 57 kHz that is amplitude-modulated by a data signal present in digital form, and to modulate the radio frequency with that multiplex signal. The data contained in the digital data signal serve, inter alia, to automatically tune a radio receiver (especially a mobile one) in order to optimize the reception quality of a received audio program, and moreover to inform the listener.

Existing radio transmission systems established with extensive coverage, e.g. in particular the above-described Radio Data System (RDS) for audio broadcasting or the Videotext system for television broadcasting, have a limited transmission capacity for data signals. In the case of the Radio Data System, the transmission capacity for data signals is defined by the data rate stipulated in the aforementioned RDS specification. Because of the proximity of the subcarrier to the spectrum of the audio signal, an expansion of the frequency range occupied by modulation of the subcarrier with the data signal is obviously not possible. Another obstacle to any increase in the data rate of the RDS signal, particularly in the case of mobile radio receivers, is an occasionally fluctuating or insufficient reception quality, which with a higher data rate would result in a further degradation of the receivability of the data signal.

German Patent 35 36 820 C2 discloses one possibility for displaying in a mobile radio receiver a traffic message that comprises a large data volume, in such a way that codes containing memory addresses are broadcast by the data signal of the Radio Data System; the memory addresses address memory cells in the mobile radio receiver in which defined components of traffic data that are to be displayed are stored. It is thus possible, by transmitting a suitable address sequence, to display even complex data by synthesizing the data from predefined stored data components. This method has become known by the abbreviation TMC (Traffic Message Channel). Even the TMC method, however, is ultimately not suitable for increasing transmission capacity; in addition, receiver-side memory capacity must be provided in order to store the data components. Lastly, the volume and nature of the data that can be displayed are limited by the contents of the receiver-side memory.

In addition, correct reception of the additional data is often not ensured, especially in the context of changeable reception situations in mobile radio receivers.

### ADVANTAGES OF THE INVENTION

The method according to the present invention for transmitting data via a radio transmitter and the method according to the present invention for receiving data broadcast by a radio transmitter, having the features of the independent method claims, have the advantage of creating a capability for increasing the transmission capacity for the transmission of data from a radio provider to a radio receiver. Advantageously, for this purpose existing radio transmission systems are combined, without complex modifications, with the capabilities of the Internet which possesses a high data transmission capacity.

It is particularly advantageous in this context to transmit an Internet address as part of a data signal transmitted alongside program content, since this prevents any negative effect on the program signal by the Internet address that is to be transmitted.

It is further advantageous to use for the transmission of Internet addresses existing, widely disseminated transmission paths accepted by the user, e.g. in particular the Radio Data System or the SWIFT/DARC standard in the case of radio broadcasting, or the Videotext signal in the case of television broadcasting.

After corresponding dissemination and acceptance by users, radio signals broadcast according to a standard for digital terrestrial or satellite radio, in particular according to the Digital Audio Broadcasting (DAB) standard or Digital Satellite Radio (DSR) standard, are furthermore of particular interest as a transmission medium for Internet addresses because of their higher transmission capacity.

It is additionally advantageous if, after transmission of an Internet address into a radio receiver, that address is automatically selected via a communication interface (6), in particular a broadcast interface. This relieves the user of input operations that in some circumstances are perceived as burdensome; this is of interest especially in the case of radio receivers for operation in vehicles, in the interest of greater driving safety.

Advantageously, the data retrievable at the transmitted Internet address can also be used to control the radio receiver or components connected to the radio receiver or to the communication interface. An example that may be mentioned is the AF lists usually transmitted by the RDS signal, which in the case of a mobile radio receiver often can be received only partially or erroneously because of poor reception conditions. Transmission of these auxiliary control data via the communication interface is less error-prone, and because of the higher transmission capacity is performed more quickly than via radio.

The method according to the present invention for controlling a radio receiver or a device connected to the radio receiver, having the features of the further independent method claim, has the advantage that the radio receiver can be caused, by way of control data broadcast via radio and formulated as an Internet address, to automatically access specific data of an Internet provider and to perform control functions as defined by the data of the Internet provider, or to make the data of the Internet provider accessible to the device connected to the radio receiver in order to control its functions. This offers the particular advantage that the provider's data can be loaded or transmitted via the Internet at a high data rate and moreover with high data security.

### DRAWINGS

Exemplary embodiments of the invention are depicted in the Figures and will be explained below in more detail.

In the drawings:

FIG. 1 schematically shows a radio transmitter that broadcasts a radio program signal generated by a radio provider on a radio frequency as a radio signal; and a block diagram of a radio receiver for receiving the radio signal and for evaluating the data contained in the radio signal;

FIG. 2 schematically shows the construction of a data signal according to the RDS standard.

### DESCRIPTION OF THE EXEMPLARY EMBODIMENTS

In conjunction with the present invention, the term “radio” is not limited to the meaning often given to it, of sound broadcasts transmitted via an AM- or FM-modulated radio frequency (often also referred to colloquially in Germanspeaking countries as “Radio”). On the contrary, “radio” is understood here as any transmission of data of a data provider to a plurality of receivers. Examples that may be cited, in addition to known FM or AM audio broadcasting, are terrestrial digital audio broadcasting known under the abbreviation DAB (Digital Audio Broadcasting), digital satellite-based audio broadcasting known as DSR (Digital Satellite Radio), and satellite, cable, and terrestrial television.

“Radio” is also, in conjunction with the present invention, not limited to wireless broadcast transmission by electromagnetic waves, but rather extends beyond that to both wireless and cable-based transmission, for example via copper or glass-fiber lines.

The method according to the present invention for transmitting data via a radio transmitter, the method according to the present invention for receiving data broadcast by a radio transmitter, and a radio receiver according to the present invention are explained below using the example of an RDS radio transmitter and an RDS radio receiver provided for mobile use, in particular in a motor vehicle, which are depicted in FIG. 1.

A radio provider 3 generates a radio program signal 31 that comprises an audio program signal, namely music or voice segments, that are provided for acoustic reproduction in a radio receiver. In addition to the audio program signal, radio program signal 31 that is to be transmitted contains a data signal which contains additional data provided in the aforementioned RDS specification.

The RDS information signal, a portion 9 of which is depicted in FIG. 2, is made up of a sequence of data groups, called simply groups 90. Each of the groups encompasses four data blocks, called simply blocks 91, 92, 93, and 94, which usually are referred to as blocks A, B, C, and D. Each block encompasses 26 bits; the first sixteen bits of each block constitute the actual data word 911, 921, 931, and 941, while the remaining ten bits 912, 922, 932, and 942 of each block represent a superposition of a test word derived from the data word, which serves for error detection and (if applicable) correction, and an offset word that allows block synchronization of a radio receiver.

For transmission of different types of data, the RDS specification provides for different group types which are serially arranged in an undefined sequence to form the RDS data signal. Specific data types regarded as particularly important are transmitted in all or a majority of the group types; other information, however, especially of greater volume, is limited to specific group types. The proportions of specific group types in the RDS signal and the repetition rate are defined in the RDS specification for specific group types; the remaining transmission capacity can be used at the transmitter end for any desired data and therefore any group types in the context of the RDS specification.

Data word 921 of block B (92) contains a four-bit group type identifier 923 to identify the group type. A version bit 924 following the group type identifier serves to identify two different versions of the same group type. Regardless of the group type, group type identifier 923 and version bit 924 are always transmitted in data word 921 of block B (92).

Also adjacent to group type version bit 924 in data word 921 of block B, regardless of the group type, are a one-bit traffic program (TP) identifier 925, which indicates whether traffic data are being transmitted within the received radio program; and a five-bit program type (PTY) identifier 926 for distinguishing among, for example, news, sports, and music programs of various styles.

Data word 911 of block A (91) contains, again regardless of the group type, a program identifier (PI) 913 that is uniquely associated with a radio program and thus permits unequivocal identification of a radio program. Since a specific radio program is usually broadcast by a plurality of radio transmitters and on a plurality of radio frequencies, the program identifier allows a radio receiver to automatically locate those radio frequencies on which a specific program is being broadcast. If reception of a radio frequency currently being received is deteriorating, it is thus possible on the basis of the program identifier to ascertain alternative radio frequencies that are broadcasting the same program and possibly exhibit, at the present receiver location, better reception quality than the radio frequency presently being received. In the case of a group of group type version B, i.e. in which version bit 924 has a logical value of “1”, data word 931 of block C (93) also includes the program identifier (PI).

Data word 941 of block D (94) makes available other group-type-specific data. The same is true of data word 931 of block C (93) in the context of a version A group, i.e. in which group type bit 924 has a logical value of “0”.

In the context of group type 2, radiotext data (RT) 943 (or 943 and 933) are transmitted in data word 941 of block D (94) (and in the case of version A, also in data word 931 of block C (93)). “Radiotext” is a coded character transmission, the transmitted characters being provided in accordance with the RDS specification for display on a display unit of a radio receiver.

In the case of a type 2 group, the remaining five bits of data word 921 of block B contain on the one hand a so-called text A/B flag 927, and a text segment address 928. Text segment address 928, constituting the last four bits of data word 921 of block B, indicates the position at which the characters transmitted in block D (group 2B) or blocks C and D (group 2A) are to be displayed within the character display. The text A/B flag, on the other hand, indicates whether the transmitted characters are to overwrite an existing character display, or if the displayed characters are to be deleted before the characters currently being transmitted are displayed.

According to the present invention, the RDS data signal is also used to transmit Internet addresses (URLs=Uniform Resource Locators). In the present exemplary embodiment, a URL is transported in a type 2 group instead of or as part of a radiotext datum.

A URL (see also [http://web.urz.uni-heidelberg.de//ausbildung/unterlagen/internet/abkurs/netsc4/ur l.shtml]) contains the address and name of a WWW document as well as a selected transmission protocol. The latter, in the case of the URL just cited, is http (=Hypertext Transfer Protocol). Alternatively, a URL can also contain concrete query commands, for example

[http://de.ink.yahoo.com/bin/query-de?p=url&hn=7&hc=0&hs=112], with which the above explanations on the topic of URLs were found.

The URL is made known, preferably introduced, by way of a characteristic character sequence within radiotext information 943 of block D (group type B) or 933 and 943 of blocks C and D (group type 2A). The character sequence identifying an Internet address can be a constituent of the Internet address itself, and for example can be constituted by or encompass the familiar character sequence “//” that introduces an Internet address. To identify the end of an Internet address, especially when the Internet address is transmitted within a radiotext character sequence provided for display on display unit 26, provision is also made, in order to distinguish characters of the Internet address from radiotext characters that are to be displayed, for marking the end of the Internet address, preferably by a distinctive character sequence, e.g. “//”. Preferably a URL within the RDS RT information is terminated by a character sequence that differs from the character sequence which introduces a URL (i.e. “//” in the selected example), for example “\\”. This prevents any transmitter-side misinterpretation of a terminating character sequence “//” as the beginning of an Internet address if the introductory character sequence “//” was not received, for example because of low reception quality at the receiver location or because reception of the RDS signal began during transmission of the URL.

Alternative possibilities for identifying a URL within the RDS signal are, of course, possible, and are within the context of the present invention. For example, it is also possible to reserve and use for the transmission of URLs group types of the RDS signal that have not previously specified in detail. A URL is then recognizable, for example, from the group type.

Radio program signal 31 generated by the radio provider, which encompasses the audio program signal and the RDS data signal containing at least one Internet address, is conveyed to at least one radio transmitter 1 via a first communication network 4, which is configured for example in the form of a cable connection or a radio relay connection between radio provider 3 and radio transmitter 1. Transmission of radio program signal 31 from provider 3 to radio transmitter 1 is accomplished in such a way that the audio program signal and data signal, the latter in the form of a digital data stream, are conveyed to radio transmitter 1 as separate signals. Radio transmitter 1 has an RDS modulator that amplitude-modulates a 57 kHz subcarrier with the digital data stream of the RDS data signal, supplemented with transmitter-specific data such as a list of alternative radio frequencies.

The list of alternative radio frequencies (AF), also defined in the RDS specification, contains those radio frequencies on which the same radio program 31 is being broadcast. It is proposed in previously published EP 0 527 275 B1 to broadcast the lists of alternative radio frequencies within the RDS data signal in such a way that each radio frequency of the broadcasting radio transmitter is transmitted in paired fashion with a radio frequency of another radio transmitter.

According to Europen Patent 0 527 275 B1, radio transmitter 1 adds to the RDS data stream generated by radio provider 3 the transmitter-specific list of alternative frequencies (AF), in which each alternative radio frequency on which the same program is being broadcast is associated in paired fashion with the radio frequency of radio transmitter 1, yielding the RDS data signal that is to be transmitted. The alternative frequencies are preferably conveyed to radio transmitter 1 as part of the RDS data stream.

The radio transmitter moreover has a multiplexer in which the audio program signal, which occupies a frequency range from 0 to 53 kHz in the baseband, is combined in known fashion with the 57-kHz subcarrier amplitude-modulated by the RDS data signal to yield the multiplex signal which is to be transmitted, containing the data of radio program signal 31.

Lastly, in a frequency modulator of radio transmitter 1, the radio frequency of radio transmitter 1 is frequency-modulated, again in known fashion, with the multiplex signal containing the radio program signal to form radio signal 11; lastly, radio signal 11 is broadcast via a transmitting antenna of radio transmitter 1 in the form of electromagnetic radiation.

Radio signal 11 of radio transmitter 1 is received by a receiving antenna 20 of a radio receiver 2 located within the transmission range of radio transmitter 1. If further radio transmitters are receivable at the present location of radio receiver 2, antenna signal 201 of receiving antenna 20 of radio receiver 2 consists of a superposition of radio signals of various radio transmitters, from which radio signal 11 of radio transmitter 1 is selected by a receiver section 21 of the radio receiver that can be tuned as a function of a tuning control signal 251. Receiver section 21 has, in a manner known per se, the means necessary for reception and selection of one of a plurality of receivable radio signals. The receiver section also has a frequency demodulator, so that multiplex signal 211 modulated with the radio frequency of radio transmitter 1 is present at the output of receiver section 21.

Multiplex signal 211 is conveyed to a reproduction apparatus 22 that has, in a manner known per se, the means necessary for acoustic reproduction of the audio program signal contained in multiplex signal 211.

Multiplex signal 211 is additionally conveyed to an RDS decoder 23 that has, in known fashion, the means necessary for isolating the RDS data from multiplex signal 211. A first output of RDS decoder 23 makes available for further processing RDS data 232 recovered from multiplex signal 211, including program identifier 913.

The radio receiver furthermore has a controller 25 for controlling the functions of radio receiver 2; and a user interface 26, connected to controller 25, which encompasses a display unit activated on the basis of a display control signal 252 generated by controller 25, and an input unit for the input of operating commands by the user, which are conveyed as operating signals 261 to controller 25. Also conveyed to controller 25 are RDS data 232 made available at the first output of the RDS decoder.

Radio receivers as described to this point are commonly known and are produced and sold by the million, so that the configuration and manner of operation of the radio receivers just described can be assumed to be known and therefore need not be described in more detail. Cited as one example of such a known radio receiver is the “San Francisco RDM 169” car radio unit offered in the current sales brochure of the company styled Blaupunkt-Werke GmbH, Hildesheim.

The radio receiver according to the present invention furthermore has a recognition circuit 24, connected to a second output 232 of RDS decoder 23, for recognition and isolation of an Internet address transmitted as part of the radiotext information within the RDS data signal. If RDS signal groups of type 2 are contained in the received radio signal 11, the radiotext signals as well as the pertinent text segment address signals and text A/B signals are present at the second output of the RDS decoder. These signals are checked in the recognition circuit for the presence of at least one Internet address. In the case described, i.e. when an Internet address transmitted within the RT information is identified by characteristic character sequences—such as, for example, the character sequence “//” introducing an Internet address, and a second character sequence, for example “\\”, placed directly after the Internet address—recognition circuit 24 checks the RT information for precisely those characteristic character sequences. A character sequence enclosed by the characteristic character sequences is recognized by recognition circuit 24 as an Internet address.

Constituents 242 of the radiotext signal that do not contain an Internet address, but rather are provided for display on display unit 26 of radio receiver 2, are conveyed via RDS decoder 23 to controller 25, which by way of a display control signal 252 activates display unit 26 in known fashion to display the radiotext signal. Preferably these constituents 242 of the radiotext signal are delivered to controller 25 in the group format, type 2A or 2B. With respect to the radiotext signal, recognition circuit 24 thus acts as a filter that eliminates from the radiotext signal those data not provided for display on display unit 26 of the radio receiver.

An Internet address contained in the radiotext signal and recognized by recognition circuit 24 is conveyed to a memory 27 and stored, preferably together with program identifier 913 of the radio program presently being received, which is isolated by controller 25 from the RDS data present at the first output of RDS decoder 23 and conveyed to the memory as signal 254.

According to the present invention, the radio receiver described has a communication software program 250, preferably implemented in controller 25, that hereinafter is referred to simply as a browser 250. The purpose of browser 250 is to create a communication connection between radio receiver 2 and the so-called Internet (which is depicted in the Figure as a second communication network 5) in accordance with an Internet address 271 read out from memory 27 in response to a retrieval instruction 255, and to control communication between radio receiver 2 and Internet 5. To create a communication connection between radio receiver 2 and Internet 5, browser 250 accesses a communication interface 6 that, in the present exemplary embodiment, is configured in the form of a mobile radiotelephone 6 functioning according to the GSM standard.

In accordance with an Internet address 256 conveyed to it by the browser, mobile radiotelephone 6 creates a radio connection via a transmission/reception antenna 61 to a mobile radio base station 7, equipped with a second transmission/reception antenna 71, in whose radio cell the radio receiver is located. Mobile radio base station 7 forwards query signal 72 containing Internet address 256 to Internet 5, whereupon a connection is created to the Internet data provider (called simply “provider”) 3 identified by Internet address 256. In response to query signal 72, provider 3 makes available data 32 that are conveyed via Internet 5 to mobile radio base station 7 and from there via the existing mobile radio connection to mobile radiotelephone 6 of radio receiver 2.

For the discussion to follow, it is assumed that provider 3 selected by browser 250 in accordance with Internet address 271 is radio provider 3 whose radio program 31 is presently being received by radio receiver 2, and which also makes data 32 available via Internet 5.

The data made available by radio provider 3 via Internet 5 can be:

data suitable for display on display unit 26 of radio receiver 2, for example a program summary, the title and performer of a musical piece presently being transmitted, or data interactively selectable by the user by way of operating inputs on the user interface, for example in a manner comparable to the Videotext system of broadcast television;

control data for radio receiver 2, for example an AF list which, especially in the case of a radio signal received with low reception quality, is receivable via the mobile radio communication interface 6 with greater data security than via the radio signal;

further Internet addresses at which, for example, different or additional data, for example data about other programs of the same radio provider, can be retrieved; or

control data for external components 8 connected to radio receiver 2, for example road condition or traffic data for a navigation device for calculating routes of travel from a starting point to a destination in consideration of stored map data and additional road condition or traffic data.

In the event the data 32 made available by provider 3 are data provided for display on a display unit, browser 250 reads Internet data 601 available in communication interface 6 into controller 25 and controls the output thereof via display unit 26 by a corresponding display control signal 252.

If further Internet addresses 32 are present, they are advantageously written into memory 27 as a signal 602 made available by mobile radiotelephone 6.

Access to a specific Internet address 271 stored in memory 27 is accomplished either automatically upon initiation by controller 25, or in response to a corresponding user input via user interface 26.

A first alternative embodiment of the invention is directed toward radio receivers other than the RDS radio receiver described above. The radio receiver according to the present invention can thus also, for example, be embodied in the form of a television receiver. In this case, for example, the Videotext signal can be used for transmission of the Internet addresses. In addition, the radio receiver can also, for example, be embodied as a receiver for digital radio, for example as a DAB (Digital Audio Broadcasting) or DSR (Digital Satellite Radio) receiver, in which context transmission channels provided in the corresponding radio transmission system are used for transmission of the Internet addresses.

A second alternative embodiment is directed toward wire-based radio transmission from radio provider 3 to radio receiver 2. The generally known systems of so-called cable television and so-called cable radio may be mentioned as examples of this. In the case of cable radio, the Internet addresses can again be transmitted as part of the radio data signal, and in the case of cable television, for example, as part of the Videotext signal.

A third alternative embodiment is directed toward the type of Internet access on the part of radio receiver 2. Instead of an embodiment of the communication interface as a GSM mobile radio interface, it can also function on the basis of the UMTS mobile radio standard, which on the basis of present knowledge will be widely disseminated in the future. Alternatively, in the case of a radio receiver provided for stationary (in particular, residential) operation, a wire-based connection of radio receiver 2 can be provided, for example via a telephone connection by a modem embodied as part of communication interface 6, or by an ISDN connection. Lastly, the so-called GPRS standard is also a possibility for connecting radio receiver 2 to Internet 5.

A fourth alternative embodiment is directed toward the transmission, from the radio transmitter to the radio receiver, of URLs containing query commands. These query commands can be formulated in order to control the radio receiver. This is explained with reference to the exemplary embodiment described below.

According to the fourth alternative embodiment, the radio transmitter transmits URLs in the form of the aforementioned query commands in such a way that the query commands access specific data offerings of provider 3 in accordance with the provider's selection. These specific data offerings can encompass, for example a list of alternative radio frequencies (AF list) broadcasting the same radio program as the one on the radio frequency presently being received. The AF list queried as a consequence of query command 72 is then transmitted as Internet data 32 by provider 3 (in the form of radio provider 3) via Internet 5, base station 7, and communication interface 6 of the radio receiver, into radio receiver 2, where it is stored in a radio frequency memory (not depicted) of the radio receiver. This ensures particularly fast and dependable transmission of the AF list from radio provider 3 to radio receiver 2.

In similar fashion, additional control data can also be conveyed to radio receiver 2 via Internet 5 rather than, for example, via the radio data signal. One example thereof that may be mentioned is influencing a navigation device 8 connected as additional component 8 to radio receiver 2.

According to this, navigation device 8 calculates a route of travel from a present vehicle location—which is determined by the sensor apparatus of the navigation device, for example by a GPS (Global Positioning System) receiver known per se—to a destination defined by the user. The route calculation is performed on the basis of traffic route data stored, for example, on a CD. Preferably the route calculation can be performed in consideration of a present traffic situation, for example construction areas, traffic jams, etc., the traffic situation data usually being conveyed to the navigation device in coded form via a TMC radio receiver as mentioned above.

According to the present invention, radio receiver 2 can now have conveyed to it from radio transmitter 1, for example by the RDS signal, URLs formulated as queries that refer to current traffic situation data made available by provider 3 on the Internet. Transmission of the URL causes the radio receiver to load, via the Internet, traffic situation data 32 made available by provider 3. These data are conveyed to navigation device 8 connected to radio receiver 6, which takes them into account for route calculation. As compared to RDS TMC data, the current traffic situation data loaded via the Internet are receivable at a higher data rate and with greater data security.

What is claimed is:

1. A method for transmitting data via a radio transmitter,
wherein the data include at least one Internet address.

2. The method as defined in claim 1,
wherein the at least one Internet address is transmitted as part of a data signal transmitted alongside a program content.

3. The method as defined in claim 2,
wherein the at least one Internet address is transmitted as part of a data signal transmitted according to the Radio Data System (RDS) standard or the SWIFT/DARC standard.

4. The method as defined in claim 2,
wherein the at least one Internet address is transmitted within a Videotext signal.

5. The method as defined in claim 1,
wherein the at least one Internet address is transmitted within a radio signal according to a standard for digital terrestrial or satellite radio, in particular according to the Digital Audio Broadcasting (DAB) standard or the Digital Satellite Radio (DSR) standard.

6. A method for receiving data broadcast by a radio transmitter,
wherein the data include at least one Internet address.

7. The method as defined in claim 6,
wherein the at least one Internet address is transmitted as part of a data signal transmitted alongside a program content, in particular according to the Radio Data System (RDS) standard, the SWIFT/DARC standard, or the Videotext standard.

8. The method as defined in claim 6,
wherein the at least one Internet address is transmitted within a radio signal according to a standard for digital terrestrial or satellite radio, in particular according to the Digital Audio Broadcasting (DAB) standard or the Digital Satellite Radio (DSR) standard.

9. The method as defined in one of claims 6 through 8,
wherein the at least one Internet address is isolated within a radio receiver suitable for reception of the broadcast data.

10. The method as defined in one of claims 6 through 9,
wherein at least one of the at least one addresses is automatically selected via a communication interface (6), in particular a radio interface.

11. The method as defined in claim 10,
wherein data available at the or a selected Internet address are retrieved via the communication interface.

12. The method as defined in claim 11,
wherein data transmitted via the communication interface are outputted optically or acoustically via the radio receiver or a separate output unit.

13. The method as defined in claim 11,
wherein data transmitted via the communication interface are used to control the radio receiver or other components connected to the radio receiver or directly to the communication interface.

14. A radio receiver,
characterized by a recognition circuit (24) for the isolation of Internet addresses from received data transmitted by radio.

15. The radio receiver as defined in claim 14,
characterized by a communication interface (6), in particular a radio interface, for selection of an Internet address isolated from received data.

16. The radio receiver as defined in claim 15,
characterized by an evaluation system (250) for data retrieved via the communication interface (6) from a selected Internet address.

17. The radio receiver as defined in claim 16,
characterized by configuration of the evaluation system (250) for the generation of control signals on the basis of data retrieved from the selected Internet address, in order to control the radio receiver (2) or components connected to the communication interface (6).

18. A method for controlling a radio receiver or a device connected to the radio receiver by data received by the radio receiver, wherein
the data include at least one Internet address;
the at least one Internet address is formulated as a query for specific data made available by a provider; and the radio receiver or the device connected to the radio receiver is controlled as a function of data queried via a communication interface in accordance with the at least one received Internet address.
